(19) United States
(12) Patent Application Publication
(10) Pub. No.: US 2025/0323519 A1
(43) Pub. Date: Oct. 16, 2025

(54) DISCONNECTION DEVICE FOR AN ELECTRIC CHARGING DEVICE, POWER SUPPLY DEVICE WITH SUCH A DISCONNECTION DEVICE, AND ENERGY STORAGE DEVICE WITH SUCH A DISCONNECTION DEVICE

(71) Applicant: ads-tec Energy GmbH, Nürtingen (DE)

(72) Inventors: Holger DREHER, Holzgerlingen (DE); Holger OCHS, Mötzingen (DE)

(21) Appl. No.: 19/176,279

(22) Filed: Apr. 11, 2025

(30) Foreign Application Priority Data
Apr. 11, 2024 (DE) 102024110207.1

(51) Int. Cl. H02J 7/00

(52) U.S. Cl. CPC H02J 7/00714; H02J 7/00032; H02J 7/007192

(57) ABSTRACT

The invention relates to a switch-off unit for an electric charging device with a [switch-off arrangement] having a first controllable power semiconductor component, a second controllable power semiconductor component and a diode, and a switch-off control device, wherein
the first power semiconductor component and the second power semiconductor component are arranged antiserially, wherein
the diode, the first power semiconductor component and the second power semiconductor component are arranged as a T-circuit, wherein
the first power semiconductor component and the second power semiconductor component are configured to conduct a charging current of the charging device in a switched-on state, wherein
the switch-off control device is operatively connected to the first power semiconductor component and the second power semiconductor component and is configured for their respective control, wherein
the switch-off control device is configured to acquire a value of at least one charging parameter which is characteristic of the charging current, and
in dependence on the acquired value, to switch off the first power semiconductor component and/or the second power semiconductor component and thereby interrupt the charging current.

The invention relates to a switch-off unit for an electric charging device, a power supply device with such a switch-off unit and an energy storage device with such a switch-off unit.

When charging an energy storage device, in particular an electric vehicle, by means of a power supply device, it is necessary to ensure that a maximum charging amperage and/or a maximum charging voltage is not exceeded to prevent damage to the energy storage device and/or the power supply device. In particular, it must be ensured that an electrical connection, in particular a supply circuit and/or charging current, is interrupted in the event of a malfunction of the power supply device and/or the energy storage device.

It is known that electric vehicles have a fuse that interrupts the supply circuit and/or charging current in the event of a malfunction of the power supply device. If, for example, a short circuit occurs in the power supply device during a bidirectional charging process—when the electric vehicle is transmitting electrical energy to the power supply device—the electric vehicle transmits energy to the power supply device at such a high power that the fuse of the electric vehicle trips. The disadvantage of these fuses is that, when opened under a high current load, they have to be replaced after just a few switching operations. Such fuses can also be integrated into a battery of the electric vehicle. The electric vehicle is no longer functional after the fuse has tripped. To restore the functionality of the electric vehicle, the electric vehicle must be towed and the fuse replaced and/or activated manually. Alternatively, the entire battery must be replaced after the fuse has tripped.

It is also known that the power supply devices can have fuses. The fuses are configured to interrupt the supply circuit and/or charging current in the event of a malfunction of the power supply device. The disadvantage of this is that the reaction time of these fuses is so long that both the fuse of the power supply device and the fuse of the electric vehicle are tripped. Furthermore, it is not possible to interrupt the supply circuit and/or charging current in the event of a malfunction of the power supply device before the electric vehicle fuse is tripped and thus maintain the functionality of the electric vehicle. Another problem is that a wide variety of electric vehicles can be charged at such a power supply device, so that the power supply device does not know the tripping characteristics of the fuse of the electric vehicle and the fuse thus cannot be protected.

The object of the invention is thus to provide a switch-off unit for an electric charging device, a power supply device with such a switch-off unit and an energy storage device with such a switch-off unit, wherein the aforementioned disadvantages are at least partially eliminated, preferably avoided.

The object is solved by providing the present technical teaching, in particular the teaching of the independent claims and the embodiments disclosed in the dependent claims and the description.

The object is solved in particular by creating a switch-off unit for an electric charging device with a switch-off arrangement having a first controllable power semiconductor component, a second controllable power semiconductor component and a diode, and a switch-off control device. The first power semiconductor component and the second power semiconductor component are arranged antiserially and, in addition, the diode, the first power semiconductor component and the second power semiconductor component are arranged as a T-circuit. The first power semiconductor component and the second power semiconductor component are configured to conduct a charging current of the power supply device in a switched-on state. The switch-off control device is operatively connected to the first power semiconductor component and the second power semiconductor component and is configured for their respective control. Furthermore, the switch-off control device is configured to acquire a value of at least one charging parameter which is characteristic of the charging current and, in dependence on the acquired value, to switch off the first power semiconductor component and/or the second power semiconductor component and thereby interrupt the charging current.

In the context of the present technical teaching, in particular three electrical components are electrically connected to each other at a single connection point in a T-circuit. A first terminal of the first component, in particular the first power semiconductor component, and a first terminal of the second component, in particular the second power semiconductor component, are electrically connected to each other via the connection point. In addition, the first terminal of the first component and a first terminal of the third component, in particular the diode, are electrically connected to each other via the connection point. In addition, the first terminal of the second component and the first terminal of the third component, in particular the diode, are electrically connected to each other via the connection point. Furthermore, a second terminal of the first component and a second terminal of the third component are connected or connectable to a voltage or current source, in particular a power supply device or an energy storage device. In addition, a second terminal of the second component and the second terminal of the third component are connected or connectable to a load, in particular the energy storage device or the power provision device, wherein the voltage or current source and the load are formed differently.

In particular, the diode takes on the charging current after the interruption, which charging current is then slowly dissipated via the diode. Advantageously, it is possible to dissipate energy from a line inductance of the charging current by means of the diode. The charging current has a high amperage and a low voltage of less than 2 V when conducted via the diode. Furthermore, a switch-off time is also reduced.

The diode is particularly preferably arranged between the first power semiconductor component and the second power semiconductor component.

In a preferred embodiment, a cathode of the diode is connected to the first power semiconductor component and the second power semiconductor component.

In particular, the charging device can be a power supply device and/or an energy storage device.

Advantageously, a reaction time of the switch-off unit, in particular of the first power semiconductor component and/or the second power semiconductor component, is in the microsecond range. Advantageously, it is thus possible to interrupt the charging current of the charging device in the event of a malfunction before, for example, an energy storage device connected to a power supply device for electric charging registers the malfunction and, in particular, before a fuse of the energy storage device is tripped. This advantageously prevents damage to the energy storage device-for example, damage impairing the roadworthiness of an electric vehicle. Thus, service calls to replace fuses in the charging device, in particular the power supply device and/or the energy storage device, are also avoided.

Furthermore, due to the first power semiconductor component and/or the second power semiconductor component, the switch-off unit is advantageously configured to reversibly interrupt the charging current. The charging current can thus be restored without having to manually replace a fuse.

In addition, the switch-off unit is configured in such a way that the charging current is interrupted before a contactor of the charging device, in particular a contactor of the power supply device and/or a contactor of the energy storage device, is switched. This advantageously reduces actuation of the at least one contactor and prevents impermissibly high amperage in the at least one contactor —and in particular its actuation under current—thereby reducing damage to the at least one contactor and increasing the service life of the at least one contactor. Furthermore, due to the avoidance of high amperages in the at least one contactor, it is possible to design the at least one contactor with smaller dimensions in relation to the permissible amperages.

In addition, the switch-off unit is preferably operated autonomously—in particular independently of the charging device, in particular the power supply device and/or the energy storage device—so that the charging current can advantageously also be interrupted in the event of a fault in the charging device—for example in the event of a software crash.

In a preferred embodiment, the switch-off unit is formed as a self-sufficient device. In addition, the switch-off unit is formed independently of an embodiment of the charging device. Advantageously, this makes it possible to install the switch-off unit in an existing charging device, in particular as a retrofit component.

Furthermore, the switch-off unit is advantageously suitable for monitoring a bidirectional charging current. Advantageously, this makes it possible to monitor a charging current from the energy storage device to the power supply device and from the power supply device to the energy storage device. In particular, this can be used to charge a device energy storage of the power supply device or to stabilize or temporarily support a power grid. Advantageously, even in the event of a malfunction of the power supply device during bidirectional charging, it can be avoided that a fuse of the energy storage device is tripped and, for example, an electric vehicle is no longer functional. Rather, it is avoided that the fuse of the electric vehicle is even exposed to operation with charging parameters that deviate from normal operation and that the charging current is interrupted by the fuse as a result. This is particularly advantageous for batteries that have an integrated fuse. Because the fuse is not tripped, these batteries no longer need to be replaced at great expense. Advantageously, towing and servicing the electric vehicle can be avoided altogether.

In the context of the present technical teaching, a positive charging current is an energy transfer from the power supply device to the energy storage device. Furthermore, in the context of the present technical teaching, a negative charging current is an energy transfer from the energy storage device to the power supply device.

In one embodiment, the switch-off arrangement is configured in such a way that a positive charging current is always conducted by the second power semiconductor component. In addition, the switch-off arrangement is configured such that a positive charging current from the first power semiconductor component is interrupted in dependence on the acquired value of the at least one characteristic charging parameter. Furthermore, the switch-off arrangement is configured in such a way that a negative charging current is always conducted by the first power semiconductor component. In addition, the switch-off arrangement is configured such that a negative charging current from the second power semiconductor component is interrupted in dependence on the acquired value of the at least one characteristic charging parameter. In the present case, this is also referred to as an antiparallel arrangement, in particular as “antiparallel”.

In the context of the present technical teaching, a power semiconductor component has at least one positive pole and at least one negative pole. Preferably, a power semiconductor component also has a control terminal, wherein the switch-off control device is electrically connected to the control terminal.

It is particularly preferred that the first power semiconductor component and/or the second power semiconductor component is formed to be unidirectionally blocking.

In one embodiment, the switch-off control device is configured to generate a switch-off signal and thus interrupt the charging current.

In the context of the present technical teaching, a switch-off signal is understood in particular to mean an electrical signal. The electrical signal can be a control voltage at a gate terminal of the first power semiconductor component and/or the second power semiconductor component.

In one embodiment, the switch-off unit has a measuring device. The measuring device is configured to directly or indirectly acquire a value of the at least one charging parameter which is characteristic of the charging current. In particular, the measuring device and the switch-off control device are connected in such a way that the value acquired by means of the measuring device is transmitted by the measuring device to the switch-off control device. Alternatively or additionally, the switch-off control device is configured to read out the value acquired by means of the measuring device.

In the context of the present technical teaching, the value of the charging parameter being acquired directly means in particular that the measuring device is configured to acquire a physical variable of the charging parameter directly and, if the charging parameter is a gradient, to derive it temporally.

In the context of the present technical teaching, the charging parameter being indirectly acquired means in particular that the measuring device is configured to directly acquire a physical variable —namely a measured value of a measuring parameter—dependent on the charging parameter, for example a voltage that drops across an inductance due to an amperage gradient, as measuring parameter.

According to a further development of the invention, it is provided that the electric charging device is an electric power supply device. Alternatively or additionally, the electric charging device is an electric energy storage device.

According to a further development of the invention, it is provided that the switch-off control device is configured to compare the acquired value with a charging parameter threshold value of the at least one characteristic charging parameter and, in dependence on the comparison, to switch off the first power semiconductor component and/or the second power semiconductor component and thereby interrupt the charging current. Advantageously, it is thus possible to decide in a simple and quick manner whether to switch off the first power semiconductor component and/or the second power semiconductor component.

In one embodiment, it is provided that the charging parameter threshold value is set in dependence on a first tolerance value. The first tolerance value is characteristic of a tolerance of the charging process, in particular of the charging parameter. Advantageously, this prevents the first power semiconductor component and/or the second power semiconductor component from being switched off because of an operationally normal fluctuation in the charging parameter—which is unable to cause damage. In particular, the first tolerance value increases the charging parameter threshold value.

In one embodiment, the charging parameter threshold value is set—in particular additionally—in dependence on a second tolerance value, wherein the second tolerance value is characteristic of a triggering tolerance of the switch-off unit, in particular of the switch-off of the first power semiconductor component and/or of the second power semiconductor component. In particular, the triggering tolerance of the switch-off is dependent on an instantaneous temperature of the switch-off arrangement carrying out the switch-off and/or a degree of aging of electronic components of the switch-off arrangement. In particular, the second tolerance value is up to 20% of the charging parameter or the charging parameter limit value. In particular, the second tolerance value increases the charging parameter threshold value.

In particular, the first power semiconductor component and/or the second power semiconductor component is switched off and thus the power current is interrupted if the acquired value of the charging parameter is greater than the charging parameter threshold value.

In one embodiment, the switch-off control device is configured to determine a difference between the acquired value and the charging parameter threshold value, and, in dependence on the difference, to switch off the first power semiconductor component and/or the second power semiconductor component, and thereby interrupt the charging current.

In a further embodiment, the switch-off control device is configured to determine a rate of change of the acquired value, in particular a gradient, in particular a charging parameter gradient, and to compare the rate of change with the charging parameter threshold value, in particular a gradient threshold value. Preferably, the switch-off control device is configured to determine a difference between the rate of change and the charging parameter threshold value, and, in dependence on the difference, to switch off the first power semiconductor component and/or the second power semiconductor component, and thereby interrupt the charging current.

In a preferred embodiment, the charging parameter threshold value is a fixed value. Alternatively, the switch-off unit, in particular the switch-off control device, is configured in such a way that the charging parameter threshold value can be preset and/or—preferably automatically—set by an operator of the switch-off unit.

In one embodiment, the value of the charging parameter is acquired unsigned, in particular as an amount, squared amount or square root of the squared amount. Accordingly, the charging parameter threshold value is preferably an unsigned variable, in particular an amount. Thus, the value of the charging parameter exceeding the assigned charging parameter threshold value means in particular that its amount becomes greater than the charging parameter threshold value, regardless of the sign of the value of the charging parameter.

In one embodiment, the switch-off control device is configured to directly acquire the charge parameter gradient, wherein the charge parameter gradient is compared with the predetermined gradient threshold value. A fault of the charging process is inferred if the charging parameter gradient acquired exceeds the predetermined gradient threshold value. This switches off the first power semiconductor component and/or the second power semiconductor component, thereby interrupting the charging current. Alternatively, it is provided that the charging parameter gradient is indirectly acquired by measuring a measurement parameter which is characteristic of the charging parameter gradient, wherein the measurement parameter is compared with a predetermined measurement parameter threshold value, wherein a fault of the charging process is inferred if the measurement parameter exceeds the predetermined measurement parameter threshold value. This again switches off the first power semiconductor component and/or the second power semiconductor component, thereby interrupting the charging current.

In one embodiment, the switch-off control device is configured to receive data of a data transmission between the power supply device and the energy storage device during a charging process. The data contains at least one charging parameter limit value which is characteristic of the charging process. In dependence on the at least one charging parameter limit value, the charging parameter threshold value, in particular an actual charging parameter threshold value, of the power supply device is set for a charging parameter. If the charging parameter exceeds the charging parameter threshold value, in particular the actual charging parameter threshold value, the first power semiconductor component and/or the second power semiconductor component is switched off, thereby interrupting the charging current. Optionally, it is provided that the charging parameter threshold value is set by determining a nominal charging parameter threshold value of the power supply device for the charging parameter in dependence on the at least one charging parameter limit value. It is checked whether a current actual value of the actual charging parameter threshold value of the power supply device is equal to a nominal value of the nominal charging parameter threshold value, in particular whether it has the same value. If the current actual value is not equal to the nominal value, in particular does not have the same value, the actual charging parameter threshold value is adjusted so that a new actual value of the actual charging parameter threshold value is equal to the nominal value, in particular has the same value. Further optionally, it is provided that the data is acquired on a line, a charging cable connecting the power supply device to the energy storage device, power electronics, an electrical interface and/or on a control device of the power supply device.

According to a further development of the invention, it is provided that the switch-off control device is configured to variably set the actual charging parameter threshold value. This makes it possible to adjust the charging parameter threshold value to the charging device, in particular the power supply device and/or the energy storage device, and thus to optimally set the switch-off unit in an advantageous manner.

Particularly preferably, the switch-off control device is configured to variably set the charging parameter threshold value based on at least one charging parameter limit value limiting the charging current. Advantageously, the at least one charging parameter threshold value can be flexibly adjusted to different energy storage devices. For example, the charging parameter threshold value can be set lower for a small electric vehicle with a maximum amperage of 125 A —at a voltage of 400 V this results in a power of 50 kW—than for a commercial electric vehicle with a maximum amperage of 625 A—at a voltage of 400 V this results in a power of 250 kW. Thus, various electric vehicles can be protected from damage.

In one embodiment, the switch-off control device is configured to be operatively connected to an acquisition device. Furthermore, the switch-off control device is configured to receive data of a data transmission between the power supply device and the energy storage device, in particular the at least one charging parameter limit value, acquired—directly and/or indirectly—by the acquisition device.

In one embodiment, the data of the data transmission that uses an electrical line in the low-voltage network (Powerline Communication (PLC) and/or a serial bus system (Controller Area Network (CAN) is acquired and/or received. In particular, the acquisition device is configured to receive data of a data transmission that uses an electrical line in the low-voltage network (Powerline Communication (PLC) and/or data of a data transmission that uses a serial bus system (Controller Area Network (CAN). In particular, the electrical line runs from the power supply device to the energy storage device, in particular within a charging cable. In particular, the electrical line is a line different from the power circuit within the charging cable.

In a further embodiment, it is provided that the switch-off unit has the acquisition device for acquiring at least one charging parameter limit value which is characteristic of a charging current. The acquisition device is operatively connected to the switch-off control device and configured to transmit the at least one charging parameter limit value to the switch-off control device. The acquisition device can advantageously be arranged in a housing of the switch-off unit. In particular, the acquisition device is then connected to the switch-off control device in such a way as to directly acquire data of the data transmission. Alternatively, the acquisition device is arranged outside the housing and connected to the data transmission path to indirectly, for example inductively, acquire data of the data transmission. In particular, the acquisition device can simply be placed or clamped around a charging cable or otherwise attached to the charging cable.

According to a further development of the invention, it is provided that the switch-off control device is configured to acquire as the at least one charging parameter a parameter selected from a voltage, an amperage, an amperage gradient, a magnetic field, a power, an energy flow direction and a temperature. Advantageously, it is possible to infer a malfunction by means of the at least one charging parameter.

In particular, a value of the parameter exceeds the charging parameter threshold value in the event of a malfunction, in particular in the event of a short circuit.

In one embodiment, the switch-off control device is configured to acquire an amperage as the at least one charging parameter. Typically, a fuse interrupts the charging current if the amperage of the charging current exceeds a rated amperage and for a period of exceedance an I²t value of the melting fuse is exceeded. In this case, the I²t value for a melting fuse is selected such that the period of exceedance is at least in the millisecond range before the charging current is interrupted. Advantageously, by means of the switch-off unit, due to the acquisition of the amperage, it is possible to interrupt the charging current much faster than with a melting fuse if the nominal amperage is exceeded. Preferably, the switch-off control device is additionally configured to switch off the first power semiconductor component and/or the second power semiconductor component if the acquired amperage exceeds an amperage threshold value as the charging parameter threshold value, wherein, for example, 1.3 times a nominal amperage of the energy storage device is selected as the amperage threshold value. It is particularly preferable to use the nominal amperage as the charging parameter limit value, in particular as the amperage limit value. Particularly preferably, the switch-off unit has at least one amperage component selected from a group consisting of a shunt, a Hall sensor, a current transformer, and a combination of at least two of said amperage components, wherein the switch-off control device is configured to determine an amperage as the at least one charging parameter based on a signal of the at least one amperage component.

In a further embodiment, the switch-off control device is configured to acquire a voltage as the at least one charging parameter. In particular, the switch-off control device is configured to acquire a voltage that is present at a terminal of the switch-off unit, which terminal is directly connected to the charging device. Preferably, the switch-off control device is additionally configured to switch off the first power semiconductor component and/or the second power semiconductor component if the acquired voltage exceeds a voltage threshold value as the charging parameter threshold value.

In a further embodiment, the switch-off control device is configured to acquire an amperage gradient as the at least one charging parameter. Preferably, the switch-off control device is additionally configured to switch off the first power semiconductor component and/or the second power semiconductor component if the acquired amperage gradient exceeds an amperage gradient threshold value as the charging parameter threshold value. In particular, the reaction time of the method is in the range of microseconds. In particular, it is not necessary for an amperage to reach the amperage threshold value and/or a voltage to reach the voltage threshold value before a malfunction of the charging process can be inferred. It is already sufficient if a rate of change in amperage—the amperage gradient—is outside a predetermined range or above the amperage gradient threshold value to detect a malfunction of the charging process. It is thus advantageously not necessary to know a tripping characteristic and/or a rated current of a fuse of the electric vehicle. In particular, no fixed switch-off thresholds of the charging device, in particular of the power supply device, are necessary. By means of the method, energy storage devices which have fuses with different tripping characteristics and/or rated currents can thus also be protected against damage without these tripping characteristics and/or rated currents of the charging device, in particular the power supply device, being known. Advantageously, this makes it possible to interrupt the charging current of the electrical power supply device in the event of a malfunction of the same before an energy storage device registers the malfunction and, in particular, before a fuse of the energy storage device is tripped. Particularly preferably, the switch-off unit has at least one amperage gradient component selected from a group consisting of a discrete inductance, a transformer, a Rogowski coil and a combination of at least two of said amperage gradient components, wherein the switch-off control device is configured to determine an amperage gradient as the at least one charging parameter based on a signal of the at least one amperage gradient component, in particular a voltage drop across the amperage gradient component. Advantageously, it is also possible to detect short circuits with a high rate of amperage increase quickly and effectively and thus quickly interrupt the charging current.

In one embodiment, the amperage gradient is from 20 A/s to 100 A/s for a charging device, in particular a power supply device, operated with a fault-free charging process. In contrast, the amperage gradient can be greater than 1.5 A/μs for a power supply device operated with a short-circuited energy storage device. In previous measurements, an amperage gradient of up to 340 A/μs was measured in the event of a short circuit. A ripple current of the charging current can have a ripple current gradient of up to 20 A/μs. After smoothing by means of a capacitance, in particular by means of a capacitor, the ripple current gradient of the ripple current can be up to 1 A/μs. The maximum permissible ripple current gradient according to the IEC61851-23 standard in its version valid on the date determining the priority of the present application can be 2.7 A/μs, in particular standardized to a charging amperage of 9 A with a ripple current frequency of up to 150 kHz. In particular, the ripple current is an alternating current of any frequency and waveform which is superimposed on a direct current, in particular the charging current. In particular, the charging current is superimposed with a ripple current which has a frequency of 80 kHz to 120 kHz, in particular 100 kHz.

In a preferred embodiment, the switch-off control device is additionally configured to switch off the first power semiconductor component and/or the second power semiconductor component if the acquired amperage gradient exceeds the amperage gradient threshold value. In particular, the amperage gradient threshold value is selected such that it lies in an interval between the permissible amperage gradient upper limit of the ripple current and the amperage gradient upper limit of the charging current. In particular, the amperage gradient threshold value is then from 1 A/μs to 340 A/μs, preferably from 1.5 A/μs to 340 A/μs, particularly preferably 1.3 A/μs.

In a further embodiment, the switch-off control device is configured to acquire a voltage gradient as the at least one charging parameter. In particular, the switch-off control device is configured to acquire a voltage gradient that is present at the terminal of the switch-off unit, which terminal is directly connected to the charging device, in particular the power supply device. Preferably, the switch-off control device is additionally configured to switch off the first power semiconductor component and/or the second power semiconductor component if the acquired voltage gradient exceeds a voltage gradient limit value as the charging parameter limit value.

In particular, the measuring device is configured to acquire the power, amperage or voltage directly. Alternatively or additionally, the measuring device is configured to acquire the amperage gradient indirectly—by measuring a measuring parameter which is characteristic of the amperage gradient.

In one embodiment—in which the amperage gradient is acquired indirectly—it is provided that the measuring device is configured to acquire, as the measuring parameter, a voltage that drops due to an inductance, in particular of electronic components of the charging device, in particular the switch-off control device of the charging device, across a measuring segment through which the charging current or a partial charging current dependent on the charging current flows. The voltage u(t) dropping across the measuring segment having the inductance L is directly dependent on—in particular according to the equation u(t)=L·dI(t)/dt proportional to—the time gradient of the amperage of the charging current or partial charging current I(t) and thus dependent on the amperage gradient. In one embodiment, the measuring device is configured to acquire as the measuring parameter a voltage drop across a coil through which the charging current or partial charging current flows. Alternatively, the measuring segment has the inductance as a parasitic inductance. In this context, ‘parasitic’ means in particular that a line section or multiple undefined, not clearly delimited components and/or line sections of the charging device, in particular the power supply device and/or the energy storage device, are the cause of the inductance.

According to a further development of the invention, it is provided that the first power semiconductor component has a first semiconductor switch and a first component diode, wherein the first semiconductor switch and the first component diode are arranged antiparallel. In addition, the second power semiconductor component has a second semiconductor switch and a second component diode, wherein the second semiconductor switch and the second component diode are arranged antiparallel. This ensures that an electric current flowing from the positive pole of the power semiconductor component to the negative pole of the power semiconductor component is conducted through the semiconductor switch, as the component diode is arranged in the reverse direction. Furthermore, an electric current flowing from the negative pole of the power semiconductor component to the positive pole of the power semiconductor component is conducted through the component diode, since the component diode is arranged in the forward direction. Furthermore, due to the antiserial arrangement of the first power semiconductor component and the second power semiconductor component, the first semiconductor switch and the second semiconductor switch are also arranged antiserially in the switch-off unit.

Advantageously, the first semiconductor switch and the second semiconductor switch thus form a bidirectional semiconductor switch. Furthermore, the semiconductor switches can be used to quickly interrupt the charging current by means of a corresponding gate signal. In addition, due to the antiserial arrangement of the first power semiconductor component and the second power semiconductor component, the first component diode and the second component diode are also arranged antiserially in the switch-off arrangement.

In a first embodiment, the switch-off control device is configured to generate a first monitoring signal in dependence on a first semiconductor forward voltage of the first semiconductor switch and the charging parameter limit value. In addition, the switch-off control device is configured to generate a second monitoring signal in dependence on a second semiconductor forward voltage of the second semiconductor switch and the charging parameter limit value. Furthermore, the switch-off control device is configured to generate a switch-off signal for interrupting the charging current in dependence on the first monitoring signal and the second monitoring signal. In particular, the first monitoring signal and the second monitoring signal are combined by means of an OR operation, so that the switch-off signal is generated if the first monitoring signal and/or the second monitoring signal indicate a malfunction.

In a second embodiment, the switch-off control device is configured to acquire the first semiconductor forward voltage of the first semiconductor switch, the second semiconductor forward voltage of the second semiconductor switch, a first component diode forward voltage of the first component diode and a second component diode forward voltage of the second component diode. In addition, the switch-off control device is configured to generate a monitoring signal in dependence on the first semiconductor forward voltage, the second semiconductor forward voltage, the first component diode forward voltage and the second component diode forward voltage. Furthermore, the switch-off control device is configured to generate the switch-off signal for interrupting the charging current in dependence on the monitoring signal and the charging parameter limit value.

In one embodiment, the first semiconductor switch and/or the second semiconductor switch is formed as a field-effect transistor, in particular as a metal-oxide-semiconductor field-effect transistor (MOSFET). In particular, the metal-oxide-semiconductor field-effect transistor has a silicon carbide material. If an n-channel field-effect transistor is used, a drain terminal of the field-effect transistor is assigned to the positive pole of the power semiconductor component and a source terminal of the field-effect transistor is assigned to the negative pole of the power semiconductor component. Alternatively, if a p-channel field-effect transistor is used, the source terminal of the field-effect transistor is assigned to the positive pole of the power semiconductor component and the drain terminal of the field-effect transistor is assigned to the negative pole of the power semiconductor component. Particularly preferably, the switch-off control device is configured to acquire the semiconductor forward voltage, in particular a gate-source voltage of the field-effect transistor, and to determine therefrom an amperage and/or a voltage as the at least one charging parameter.

In a further embodiment, the first semiconductor switch and/or the second semiconductor switch is formed as a bipolar transistor with an insulated gate electrode. If an n-channel bipolar transistor is used, a collector terminal of the bipolar transistor is assigned to the positive pole of the power semiconductor component and an emitter terminal of the bipolar transistor is assigned to the negative pole of the power semiconductor component. Alternatively, if a p-channel bipolar transistor is used, the emitter terminal of the bipolar transistor is assigned to the positive pole of the power semiconductor component and the collector terminal of the bipolar transistor is assigned to the negative pole of the power semiconductor component. Particularly preferably, the switch-off control device is configured to acquire the semiconductor forward voltage, in particular a base-emitter voltage of the bipolar transistor, and to determine therefrom an amperage and/or a voltage as the at least one charging parameter.

In one embodiment, the first semiconductor switch and/or the second semiconductor switch is an insulated-gate bipolar junction transistor (IGBT). In particular, it has a silicon material. In particular, this makes it possible to interrupt the charging current so quickly that a short-circuit current occurring in the event of a malfunction does not exceed a value of I=1 kA.

In one embodiment, a cathode of the component diode of the power semiconductor component is assigned to the positive pole of the power semiconductor component and an anode of the component diode of the power semiconductor component is assigned to the negative pole of the power semiconductor component.

In a particularly preferred embodiment, the first of the power semiconductor component and the second of the power semiconductor component are formed identically.

According to a further development of the invention, it is provided that the switch-off control device is configured to switch off the first power semiconductor component and/or the second power semiconductor component by means of the control voltage.

In particular, the control voltage for switching off the first power semiconductor component and/or the second power semiconductor component is preferably at most 0 V. In particular, the first power semiconductor component is switched off and thus the charging current is interrupted if a control voltage of at most 0 V is present at the first power semiconductor component, in particular at a gate terminal of the first power semiconductor component. Furthermore, the second power semiconductor component is switched off and thus the charging current is interrupted if a control voltage of at most 0 V is present at the second power semiconductor component, in particular at a gate terminal of the second power semiconductor component. In particular, the first power semiconductor component and the second power semiconductor component are switched on and thus the charging current is not interrupted if a control voltage of 15 V to 20 V is applied to the first power semiconductor component and the second power semiconductor component, in particular to the respective gate terminals.

According to a further development of the invention, the switch-off unit has a tempering device. The tempering device is configured to temper the first power semiconductor component and/or the second power semiconductor component.

In particular, the tempering device is configured to cool or heat the first power semiconductor component and/or the second power semiconductor component. In particular, it is possible for the first power semiconductor component and/or the second power semiconductor component to heat up strongly during use of the charging device due to high currents of the charging current. By means of the tempering device, the power semiconductor component can be cooled to ensure safe operation of the switch-off unit.

Alternatively or additionally, the first power semiconductor component and/or the second power semiconductor component can be preheated by means of the tempering device in order to prevent too rapid heating during operation and thus mechanical stresses on the first power semiconductor component and/or the second power semiconductor component, in particular due to thermal expansion.

In one embodiment, the tempering device has a cooling device and/or a heating device. The cooling device is preferably formed as a water cooling system or as an air cooling system. Furthermore, the heating device is preferably formed as a resistive heating element.

According to a further development of the invention, it is provided that the switch-off unit has a temperature control device. The temperature control device is configured to acquire the temperature of the switch-off unit. Alternatively or additionally, the temperature control device is configured to control, in particular regulate, a temperature of the switch-off unit.

Advantageously, it is thus possible in a simple embodiment to monitor an instantaneous temperature of the switch-off unit. Advantageously, in a more complex embodiment, it is possible to set an in particular predetermined temperature of the switch-off unit. Furthermore, it is advantageously possible to regulate the temperature of the switch-off unit and in particular to maintain it at the predetermined temperature.

Preferably, the temperature control device can be configured to carry out temperature control and/or, in particular, intelligent temperature control. Alternatively or additionally, the temperature control device may be configured to maintain the temperature of the switch-off unit within a predetermined operating temperature interval, in particular during use of the charging device.

In a particularly preferred embodiment, the switch-off unit has the tempering device and the temperature control device. In particular, the temperature control device and the tempering device are operatively connected, wherein the temperature control device is configured to control the tempering device and thus to control, in particular regulate, the temperature of the switch-off unit.

According to a further development of the invention, it is provided that the switch-off unit has a communication interface. The communication interface is configured to receive information. Alternatively or additionally, the communication interface is configured to send information.

In one embodiment, the switch-off unit, in particular the switch-off control device and/or the communication interface, is configured to receive data of a data transmission between the power supply device and the energy storage device during a charging process. The data contains at least one charging parameter limit value which is characteristic of the charging current. In dependence on the at least one charging parameter limit value, a charging parameter threshold value of the power supply device is set for a charging parameter. If the acquired value of the charging parameter exceeds the charging parameter threshold value, the charging current is interrupted, in particular to protect the power supply device and/or the energy storage device from damage.

Advantageously, the method can be used to detect and use a communication between the energy storage device and the power supply device to flexibly adjust the trigger characteristic—the charging parameter threshold value—of the interruption of the charging current to the respective energy storage device, in particular to the charging parameter limit value thereof, for example a maximum amperage of the charging current. This makes it possible to interrupt the power circuit of the electrical power supply device in the event of a malfunction of the same before an energy storage device registers the malfunction and, in particular, before a fuse of the energy storage device is tripped. By means of the variably adjusted charging parameter threshold value, the charging current can be interrupted earlier in time than by means of a fixed switch-off threshold of the power supply device, as is used for many energy storage devices. For example, the charging parameter threshold value can be adjusted to the charging parameter limit value, such as the maximum amperage of the charging current, of a wide range of electric vehicles—from small cars to trucks. This can prevent the fuse of a small car from tripping. Although it is not known to the power supply device that a small car is being charged, a charging parameter limit value, for example a maximum amperage of the charging current, is known to the power supply device. Furthermore, it is advantageously not necessary to know a tripping characteristic and/or a rated current of a fuse of the electric vehicle, so that the switch-off unit can also be used to protect energy storage devices from damage that have fuses with different tripping characteristics and/or rated currents. Critical short circuits with a high rate of amperage increase—i.e. a comparatively high amperage gradient—are also prevented by interrupting the power circuit at a still permissible amperage in relation to the currently connected energy storage device and thus ending the charging process. It is also possible to realize a comparatively small distance between an amperage that characterizes a fault-free charging process and the charging parameter threshold value. The charging parameter threshold value is preferably set at the beginning of a charging process, but can also optionally be set again during the charging process, in particular once or multiple times, in particular cyclically, and thus dynamically adjusted.

According to a further development of the invention, it is provided that the communication interface is configured to send information about an operating state of the switch-off unit. Alternatively or additionally, the communication interface is configured to receive information of a computing unit, in particular of the charging device.

In particular, the communication interface is configured to send and/or receive information wirelessly.

In particular, the information on the operating state of the switch-off unit indicates whether the first power semiconductor component and/or the second power semiconductor component is switched on or off.

Furthermore, the information about the operating state is sent to a data center and/or a monitoring unit in particular. This makes it advantageously possible to monitor an operating state of the switch-off unit regardless of a proximity to the switch-off unit.

In particular, the communication interface is configured to receive information about an energy storage device connected to the power supply device from the computing unit of the power supply device.

In a preferred embodiment, the communication interface is configured to receive information, in particular the charging parameter limit value, about an energy storage device connected to the power supply device from an acquisition device, in particular the acquisition device already described above.

In particular, the switch-off control device is configured to set and/or vary and/or adjust the evaluation of the acquired value of the charging parameter, in particular the charging parameter limit value, based on the information received. This advantageously enables, in particular, an adjustment to different charging rates or charging capacities of the energy storage device connected to the power supply device. If, for example, a first electric vehicle can be charged with 100 KW, the evaluation of the acquired value can be set more sensitively, in particular, the charging parameter limit value can be selected lower than for a second electric vehicle which can be charged with 170 kW. On the one hand, this advantageously avoids false tripping in the case of energy storage devices with a higher charging capacity and, on the other hand, avoids tripping despite a fault in the case of energy storage devices with a lower charging capacity.

In particular, the switch-off control device is configured to dynamically adjust the evaluation of the acquired value of the charging parameter, in particular the charging parameter limit value, to a charging curve of the energy storage device connected to the power supply device based on the information received. Typically, the charging power, in particular when charging electric vehicles, is not constant during the course of the charging process, but rather decreases as the vehicle battery level increases—in different ways, depending on the electric vehicle. The sensitivity of the switch-off unit can thus be adjusted to the individual charging curve of the respective energy storage device, so that false tripping and no tripping despite a fault can be avoided.

According to a further development of the invention, it is provided that the switch-off unit has an auxiliary voltage supply. The auxiliary voltage supply is configured to operate the switch-off control device, the first power semiconductor component and the second power semiconductor component. Advantageously, the switch-off unit is thus operated independently of a voltage supply by means of the charging device, so that the charging current can also be interrupted in the event of a fault of the charging device.

The object is also solved by creating a power supply device with a switch-off unit according to the invention or a switch-off unit according to one or multiple of the previously explained embodiments. A switch-off arrangement of the switch-off unit, in particular the first power semiconductor component and the second power semiconductor component, is electrically installed in series with an energy storage device connectable to the power supply device in a power circuit of the power supply device. In connection with the power supply device, the advantages already explained in connection with the switch-off unit arise in particular.

According to a further development of the invention, it is provided that the power supply device has a computing unit. The computing unit is operatively connected to the switch-off unit. The computing unit is also configured to receive data from the switch-off unit. Alternatively or additionally, the computing unit is configured to send data to the switch-off unit.

In particular, the computing unit is configured to receive data from the energy storage device connected to the power supply device. In particular, the data comprises information on a maximum charging amperage and/or a maximum charging voltage and/or a characteristic line for charging power and battery state—also referred to as a charging curve. In particular, the switch-off control device is configured to set and/or vary and/or adjust the evaluation of the acquired value of the charging parameter, in particular the charging parameter limit value, based on the maximum charging amperage and/or the maximum charging voltage and/or the characteristic line for charging power and battery state, in particular in dependence on the battery state.

According to a further development of the invention, it is provided that the power supply device additionally has a device energy storage, a charging cable and a charging plug.

In one embodiment, the switch-off unit is arranged in the device energy storage. Advantageously, the switch-off unit in the device energy storage can be easily integrated into the supply circuit and/or a cooling circuit. Furthermore, the integration is independent of a location of the power supply device and/or environmental conditions at the location of the power supply device.

In a further embodiment, the switch-off unit is alternatively or additionally arranged in the charging cable. Advantageously, the switch-off unit is independent of the power supply device and can also be retrofitted to existing power supply devices.

In a further embodiment, the switch-off unit is alternatively or additionally arranged in the charging plug. Advantageously, the switch-off unit is independent of the power supply device and can also be retrofitted to existing power supply devices. In addition, a complete line segment from the device energy storage via the charging cable to the charging plug is monitored by means of the switch-off unit. Furthermore, good dissipation of energy loss is possible with cooled charging cables.

In particular, protection of the energy storage device, especially against short circuits, is better the closer the switch-off unit is arranged to the energy storage device.

Particularly preferably, the device energy storage is a component of a base element of the power supply device. Furthermore, the base element has a computing unit and electronics for providing the electrical power. The computing unit is preferably connected to the switch-off unit, in particular the switch-off control device. In particular, communication between the computing unit of the electrical power supply device and the switch-off unit is easier to implement if the switch-off unit is arranged in the base element of the electrical power supply device.

In one embodiment—in particular, if the power supply device does not have a charging pole—the base element has a user interface, wherein a user of the power supply device can start, monitor and end a charging process via the user interface. In particular, it is also possible to stow the charging plug on the base element when the power supply device is not in use.

According to a further development of the invention, it is provided that the power supply device has a charging pole. The charging pole is electrically arranged between the device energy storage and the charging plug. A first partial charging cable connects the device energy storage to the charging pole and a second partial charging cable connects the charging pole to the charging plug. In addition, the switch-off unit is arranged in the charging pole. Advantageously, the switch-off unit can also be retrofitted to existing power supply devices. In particular, the switch-off unit in the charging pole protects against short circuits in the charging cable if the first partial charging cable bridges a large distance between the device energy storage system and the charging pole.

In the context of the present technical teaching, a charging pole is, in particular, a part of the power supply device that can be operated by a user of the power supply device. In particular, the charging pole has a charging plug receptacle and the user interface. It is also possible for the charging pole and the device energy storage system to have a spatial distance of up to 300 m. Alternatively, the charging pole and the device energy storage can also be formed as an integrated unit.

According to a further development of the invention, it is provided that the power supply device has a casing, wherein the casing has a maintenance hatch. The switch-off unit is arranged in the power supply device in such a way that at least the first power semiconductor component and/or the second power semiconductor component can be replaced via the maintenance hatch. This makes it advantageously possible to replace the first power semiconductor component and/or the second power semiconductor component quickly and easily in the event of a defect.

In one embodiment, the casing is a housing of the device energy storage. Alternatively or additionally, the casing is a housing of the charging plug. Alternatively or additionally, the casing is a housing of the charging pole.

According to a further development of the invention, it is provided that the power supply device is formed as a charging station for electrically charging an energy storage device connected to the power supply device.

In particular, the power supply device is formed as a charging station for electric vehicles.

In electrical engineering, a charging station is any device or electrical system, in particular stationary or mobile, which is used to supply energy to mobile battery-powered devices, machines or electric vehicles by simply positioning them or plugging them in without necessarily having to remove an energy storage system—such as the traction battery of an electric car. Charging stations for electric cars are sometimes also referred to as “electric charging stations” and can include a plurality of charging points. High performance charging systems or high power charging system (HPC systems) such as the combined charging system (CCS), which is widespread in Europe, are particularly well known. With generic direct current charging, direct current from the charging station is fed directly into the vehicle's battery and provided by a powerful rectifier, preferably of the charging station, from the power grid or by large buffer accumulators at solar charging stations, for example. There is a battery management system in the vehicle that communicates directly or indirectly with the charging station to adjust the current and voltage or to terminate the process when a predetermined capacity limit is reached. Power electronics are usually located in the charging station. Since the direct current connections of the charging station are connected directly to the corresponding connections of the traction battery—without a detour through an AC/DC converter of the vehicle—high charging currents can be transmitted with low losses, which enables short charging times.

In one embodiment, the charging station has at least one charging point, in particular exactly one charging point or exactly two charging points.

In particular, the charging station is designed as a fast charging station. In one embodiment, the charging station is designed as a battery-supported charging station, in particular as a battery-supported fast charging station.

The object is also solved by creating an energy storage device with a switch-off unit according to the invention or a switch-off unit according to one or multiple of the previously explained embodiments. A switch-off arrangement of the switch-off unit, in particular the first power semiconductor component and the second power semiconductor component, is electrically installed in series with a power supply device connectable to the energy storage device in a supply circuit of the energy storage device. In connection with the energy storage device, the advantages already explained in connection with the switch-off unit apply in particular.

In one embodiment, the energy storage device is formed as an electric vehicle.

The invention is explained in more detail below with reference to the drawing. The Figures show:

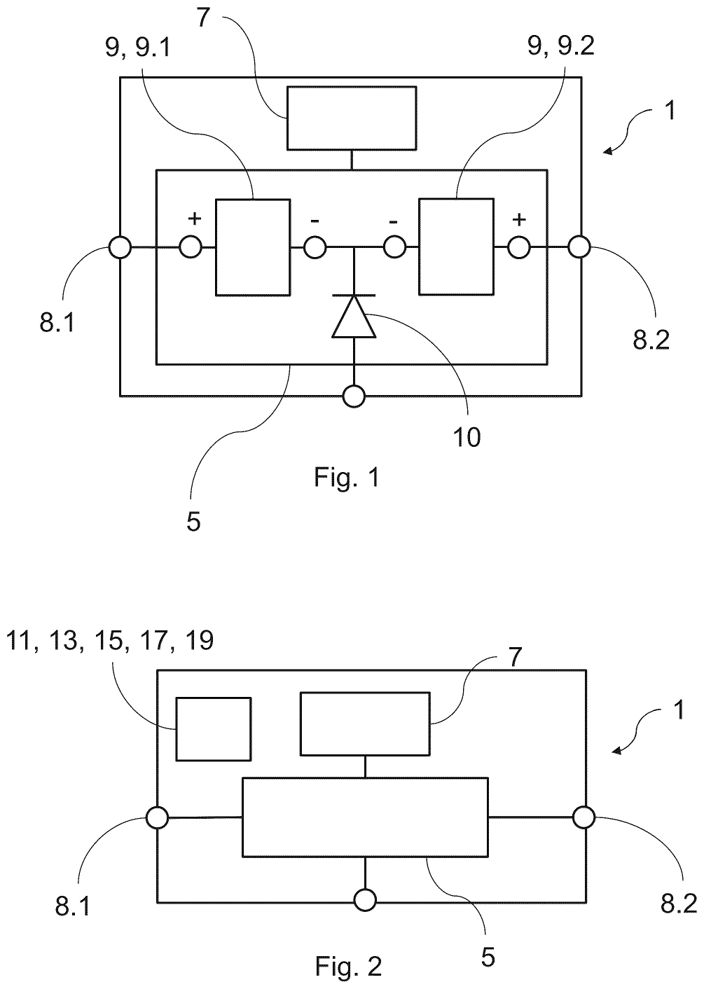

FIG. 1 shows a schematic representation of a first embodiment example of a switch-off unit,

FIG. 2 shows a schematic representation of a second embodiment example of the switch-off unit,

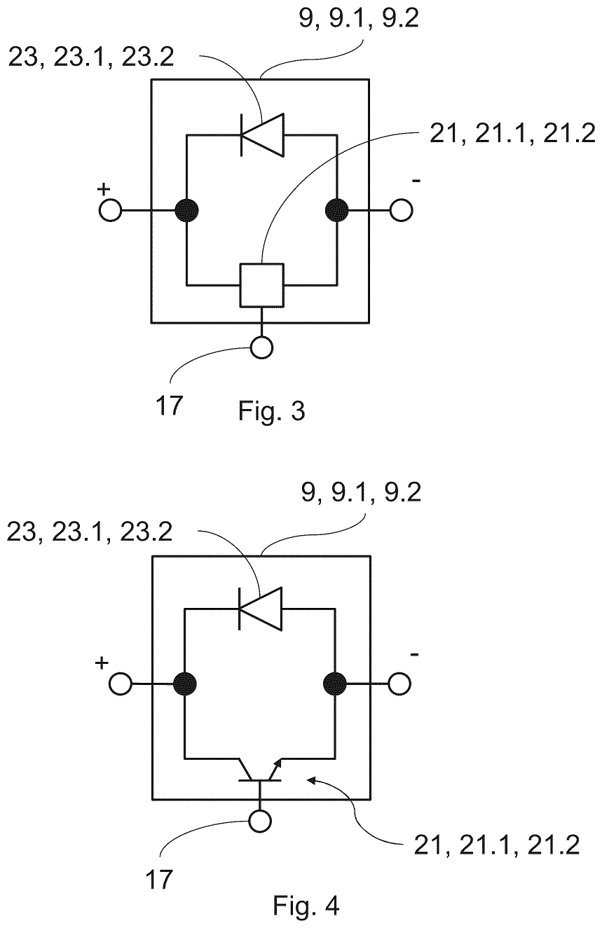

FIG. 3 shows a schematic representation of a first embodiment example of a power semiconductor component,

FIG. 4 shows a schematic representation of a second embodiment example of the power semiconductor component,

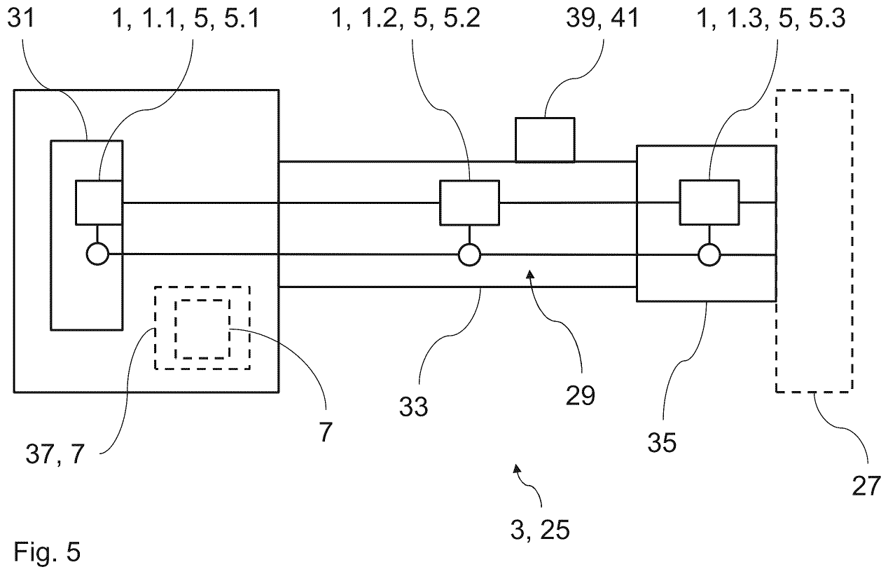

FIG. 5 shows a schematic representation of a first embodiment example of a power supply device,

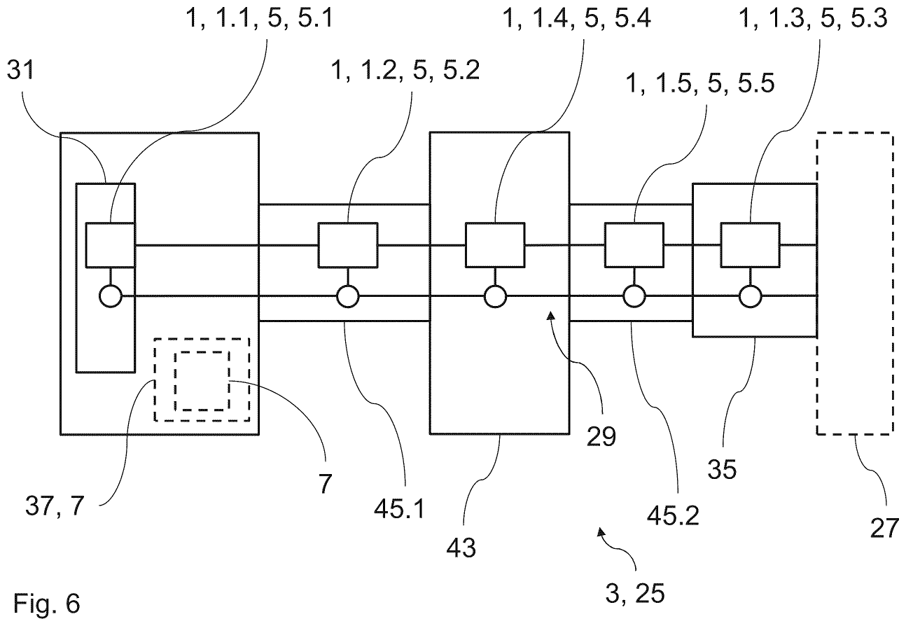

FIG. 6 shows a schematic representation of a second embodiment example of the power supply device, and

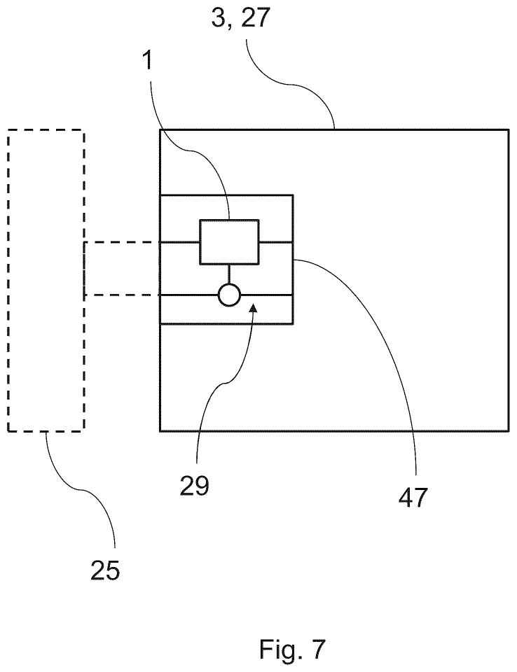

FIG. 7 shows a schematic representation of an embodiment example of an energy storage device.

FIG. 1 shows a schematic representation of a first embodiment example of a switch-off unit 1 for a charging device 3, which is shown in particular in FIGS. 5 to 7.

The switch-off unit 1 has a switch-off arrangement 5 and a switch-off control device 7. The switch-off arrangement 5 has a first controllable power semiconductor component 9.1, a second controllable power semiconductor component 9.2 and a diode 10. The first power semiconductor component 9.1 and the second power semiconductor component 9.2 are arranged antiserially and, in addition, the diode 10, the first power semiconductor component 9.1 and the second power semiconductor component 9.2 are arranged as a T-circuit. Furthermore, the first power semiconductor component 9.1 and the second power semiconductor component 9.2 are configured to conduct a charging current of the charging device 3 in a switched-on state. The switch-off control device 7 is operatively connected to the first power semiconductor component 9.1 and the second power semiconductor component 9.2 in a manner not explicitly shown and is configured for their respective control. Furthermore, the switch-off control device 7 is configured to acquire a value of at least one charging parameter which is characteristic of the charging current and, in dependence on the acquired value, to switch off the first power semiconductor component 9.1 and/or the second power semiconductor component 9.2 and thereby interrupt the charging current.

In particular, the diode 10 takes on the charging current after the interruption, which charging current is then slowly dissipated via the diode 10. The diode 10 is particularly preferably arranged between the first power semiconductor component 9.1 and the second power semiconductor component 9.2.

In a preferred embodiment, a cathode of the diode 10 is connected to the first power semiconductor component 9.1 and the second power semiconductor component 9.2.

In particular, the switch-off unit 1 has a first terminal 8.1 and a second terminal 8.2, wherein the switch-off unit 1 can be integrated into a circuit via the first terminal 8.1 and the second terminal 8.2.

In particular, due to the first power semiconductor component 9.1 and/or the second power semiconductor component 9.2, the switch-off unit 1 is configured to reversibly interrupt the charging current.

Preferably, the switch-off unit 1 is a self-sufficient component—in particular independent of the charging device 3—so that the charging current can advantageously also be interrupted in the event of a fault of the charging device 3—for example in the event of a software crash—and/or the switch-off unit 1 can be installed in an already existing charging device 3, in particular as a retrofit component.

In particular, the switch-off arrangement 5 is configured in such a way that a positive charging current is always conducted by the second power semiconductor component 9.2. In addition, the switch-off arrangement 5 is configured such that a positive charging current from the first power semiconductor component 9.1 is interrupted in dependence on the acquired value of the at least one characteristic charging parameter. Furthermore, the switch-off arrangement 5 is configured in such a way that a negative charging current is always conducted by the first power semiconductor component 9.1. In addition, the switch-off arrangement 5 is configured such that a negative charging current from the second power semiconductor component 9.2 is interrupted in dependence on the acquired value of the at least one characteristic charging parameter.

Preferably, a power semiconductor component 9 has at least one positive pole and at least one negative pole. Alternatively or additionally, the first power semiconductor component 9.1 and/or the second power semiconductor component 9.2 is formed to be unidirectionally blocking.

Particularly preferably, the switch-off control device 7 is configured to generate a switch-off signal and thus interrupt the charging current. Alternatively or additionally, the switch-off control device 7 is configured to compare the acquired value with a charging parameter threshold value of the at least one characteristic charging parameter and, in dependence on the comparison, to switch off the first power semiconductor component 9.1 and/or the second power semiconductor component 9.2 and thereby interrupt the charging current, wherein in particular the first power semiconductor component 9.1 and/or the second power semiconductor component 9.2 is switched off and thus the power current is interrupted if the acquired value of the charging parameter is greater than the charging parameter threshold value. Particularly preferably, the switch-off control device 7 is configured to variably set the charging parameter threshold value—in particular based on at least one charging parameter limit value limiting the charging current. Alternatively or additionally, the switch-off control device 7 is configured to acquire as the at least one charging parameter a parameter selected from a voltage, an amperage, an amperage gradient, a magnetic field, a power, an energy flow direction and a temperature. Alternatively or additionally, the switch-off control device 7 is configured to switch off the first power semiconductor component 9.1 and/or the second power semiconductor component 9.2 by means of a control voltage, wherein in particular the control voltage is applied to a control terminal 17 of the power semiconductor component 9—shown in FIG. 3.

In addition, the first power semiconductor component 9.1 and the second power semiconductor component 9.2 are particularly preferably formed identically.

FIG. 2 shows a schematic representation of a second embodiment example of the switch-off unit 1.

Identical and functionally identical elements are provided with the same reference numbers in all Figures, so that reference is made to the previous description in this respect.

The switch-off unit 1 according to FIG. 2 also has at least one device selected from a group consisting of a measuring device 11, a tempering device 13, a temperature control device 15, a communication interface 17, an auxiliary power supply 19, and a combination of at least two of said devices.

The measuring device 11 is configured to directly or indirectly acquire a value of the at least one charging parameter which is characteristic of the charging current. Particularly preferably, the measuring device 11 is configured to acquire the power, amperage or voltage directly. Alternatively or additionally, the measuring device 11 is configured to acquire the amperage gradient indirectly—by measuring a measuring parameter which is characteristic of the amperage gradient.

In particular, the measuring device 11 and the switch-off control device 7 are connected in such a way, which is not explicitly shown, that the value acquired by means of the measuring device 11 is transmitted by the measuring device 11 to the switch-off control device 7. Alternatively or additionally, the switch-off control device 7 is configured to read out the value acquired by means of the measuring device 11.

The tempering device 13 is configured to temper the first power semiconductor component 9.1 and/or the second power semiconductor component 9.2.

The temperature control device 15 is configured to acquire the temperature of the switch-off unit 1. Alternatively or additionally, the temperature control device 15 is configured to control, in particular regulate, a temperature of the switch-off unit 1.

Particularly preferably, the switch-off unit 1 has the tempering device 13 and the temperature control device 15. Here, the temperature control device 15 and the tempering device 13 are operatively connected, wherein the temperature control device 15 is configured to control the tempering device 13 and thus to control, in particular regulate, the temperature of the switch-off unit 1.

The communication interface 17 is configured to receive information. Alternatively or additionally, the communication interface 17 is configured to send information. In particular, the communication interface 17 is configured to send information about an operating state of the switch-off unit 1 and/or to receive information—in particular about an energy storage device 27 connected to a power supply device 25—from a computing unit 37 of the charging device 3, in particular the power supply device 25, or an acquisition device 39—shown in FIG. 5.

The auxiliary power supply 19 is configured to operate the switch-off control device 7, the first power semiconductor component 9.1 and/or the second power semiconductor component 9.2.

FIG. 3 shows a schematic representation of a first embodiment example of the power semiconductor component 9, in particular of the first power semiconductor component 9.1 and/or the second power semiconductor component 9.2.

The power semiconductor component 9 has a semiconductor switch 21 and a component diode 23, wherein the semiconductor switch 21 and the component diode 23 are arranged antiparallel. This ensures that an electric current flowing from the positive pole of the power semiconductor component 9 to the negative pole of the power semiconductor component 9 is conducted through the semiconductor switch 21, since the component diode 23 is arranged in the reverse direction. Furthermore, an electric current flowing from the negative pole of the power semiconductor component 9 to the positive pole of the power semiconductor component 9 is conducted through the component diode 23, since the component diode 23 is arranged in the forward direction.

In addition, due to the antiserial arrangement of the first power semiconductor component 9.1 and the second power semiconductor component 9.2 in the switch-off arrangement 5 of FIG. 1 and FIG. 2, a first semiconductor switch 21.1 and a second semiconductor switch 21.2 are also arranged antiserially in the switch-off unit 1. The first semiconductor switch 21.1 and the second semiconductor switch 21.2 thus form a bidirectional semiconductor switch. Furthermore, the semiconductor switch 21 can be used to quickly interrupt the charging current by means of a corresponding gate signal and/or the control voltage-in particular via the control terminal 17. In addition, due to the antiserial arrangement of the first power semiconductor component 9.1 and the second power semiconductor component 9.2, a first component diode 23.1 and a second component diode 23.2 are also arranged antiserially in the switch-off arrangement 5.

In particular, the switch-off control device 7 is electrically connected to the control terminal 17. Alternatively or additionally, the control terminal 17 is formed as a gate terminal of the semiconductor switch 21.

Particularly preferably, a cathode of the component diode 23 is assigned to the positive pole of the power semiconductor component 9 and an anode of the component diode 23 is assigned to the negative pole of the power semiconductor component 9.

Particularly preferably, when the power semiconductor components 9 are configured as shown in FIG. 3, the switch-off control device 7 of FIGS. 1 and 2 is configured to acquire a semiconductor forward voltage of the semiconductor switch 21 and to determine therefrom an amperage and/or a voltage as the at least one charging parameter.

In a first embodiment, the switch-off control device 7 of FIGS. 1 and 2 is configured to generate a first monitoring signal in dependence on a first semiconductor forward voltage of the first semiconductor switch 21.1 and a charging parameter limit value when the power semiconductor components 9 are designed as shown in FIG. 3. In addition, the switch-off control device 7 is configured to generate a second monitoring signal in dependence on a second semiconductor forward voltage of the second semiconductor switch 21.2 and the charging parameter limit value. Furthermore, the switch-off control device 7 is configured to generate a switch-off signal for interrupting the charging current in dependence on the first monitoring signal and the second monitoring signal. In particular, the first monitoring signal and the second monitoring signal are combined by means of an OR operation, so that the switch-off signal is generated if the first monitoring signal and/or the second monitoring signal indicate a malfunction.

In a second embodiment, the switch-off control device 7 of FIGS. 1 and 2 is configured to acquire the first semiconductor forward voltage of the first semiconductor switch 21.1, the second semiconductor forward voltage of the second semiconductor switch 21.2, a first component diode forward voltage of the first component diode 23.1 and a second component diode forward voltage of the second component diode 23.2 when the power semiconductor components 9 are designed as shown in FIG. 3. In addition, the switch-off control device 7 is configured to generate a monitoring signal in dependence on the first semiconductor forward voltage, the second semiconductor forward voltage, the first component diode forward voltage and the second component diode forward voltage. Furthermore, the switch-off control device 7 is configured to generate the switch-off signal for interrupting the charging current in dependence on the monitoring signal and the charging parameter limit value.

FIG. 4 shows a schematic representation of second embodiment example of the power semiconductor component 9, in particular of the first power semiconductor component 9.1 and/or the second power semiconductor component 9.2.

The semiconductor switch 21 is formed as an n-channel insulated-gate bipolar junction transistor. In this case, a collector terminal of the n-channel bipolar transistor is assigned to the positive pole of the power semiconductor component 9 and an emitter terminal of the bipolar transistor is assigned to the negative pole of the power semiconductor component 9.

Alternatively, the semiconductor switch 21 can be formed as a p-channel insulated-gate bipolar junction transistor. In this case, the emitter terminal of the p-channel bipolar transistor is assigned to the positive pole of the power semiconductor component 9 and the collector terminal of the n-channel bipolar transistor is assigned to the negative pole of the power semiconductor component 9.

Alternatively, the semiconductor switch 21 can be formed as an n-channel field-effect transistor, in particular as a metal-oxide-semiconductor field-effect transistor (MOSFET). In this case, a drain terminal of the n-channel field-effect transistor is assigned to the positive pole of the power semiconductor component 9 and a source terminal of the n-channel field-effect transistor is assigned to the negative pole of the power semiconductor component 9.

Alternatively, the semiconductor switch 21 can be formed as a p-channel field-effect transistor, in particular as a metal-oxide-semiconductor field-effect transistor (MOSFET). In this case, the source terminal of the p-channel field-effect transistor is assigned to the positive pole of the power semiconductor component 9 and the drain terminal of the p-channel field-effect transistor is assigned to the negative pole of the power semiconductor component 9.

Particularly preferably, when the power semiconductor components 9 are configured as shown in FIG. 4, the switch-off control device 7 of FIGS. 1 and 2 is configured to acquire a base-emitter voltage of the bipolar transistor or a gate-source voltage of the field-effect transistor, and to determine therefrom an amperage and/or a voltage as the at least one charging parameter.

FIG. 5 shows a schematic representation of a first embodiment example of the power supply device 25 as the charging device 3.

The power supply device 25 has at least one switch-off unit 1. The switch-off arrangement 5 of the switch-off unit 1, which is not explicitly shown here, in particular the first power semiconductor component 9.1 and the second power semiconductor component 9.2, is electrically installed in series with an energy storage device 27 connectable to the power supply device 25 in a supply circuit 29 of the power supply device 25.

Preferably, a first switch-off unit 1.1 is arranged in a device energy storage 31 of the power supply device 25. Alternatively or additionally, a second switch-off unit 1.2 is arranged in a charging cable 33 of the power supply device 25. Alternatively or additionally, a third switch-off unit 1.3 is arranged in a charging plug 35 of the power supply device 25.

Optionally, the power supply device 25 has a computing unit 37. The computing unit 37 is operatively connected to the switch-off unit 1 in a manner not explicitly shown. The computing unit 37 is also configured to receive data from the switch-off unit 1. Alternatively or additionally, the computing unit 37 is configured to send data to the switch-off unit 1. Alternatively or additionally, the computing unit 37 is configured to receive data from the energy storage device 27 connected to the power supply device 25.

Particularly preferably, the switch-off control device 7 is formed separately from the computing unit 37. Alternatively, the switch-off control device 7 is integrated into the computing unit 37 or formed as a computing unit 37, wherein in this case a first switch-off arrangement 5.1 is arranged in the device energy storage 31 and/or a second switch-off arrangement 5.2 is arranged in the charging cable 33 and/or a third switch-off arrangement 5.3 is arranged in the charging plug 35.

Preferably, the switch-off control device 7 is configured to be operatively connected to an acquisition device 39 of the switch-off unit 1. Furthermore, the switch-off control device 7 is configured to receive data of a data transmission between the power supply device 25 and the energy storage device 27, in particular the at least one charging parameter limit value, acquired—directly and/or indirectly—by the acquisition device 39. In particular, the acquisition device 39 can detect the data transmission without a galvanic connection to a data transmission path itself—in other words, listen to the data transmission, in particular electrically contactless, in particular galvanically decoupled, in particular inductively. This is preferably done on a line or the charging cable 33, for example with a preferably inductive data sniffer 41 as the acquisition device 39.

FIG. 6 shows a schematic representation of an embodiment example of a power supply device 25.

The power supply device 1 according to FIG. 6 is based on the power supply device 1 according to FIG. 5 and additionally has a charging pole 43. The charging pole 43 is electrically arranged between the device energy storage 31 and the charging plug 35. A first partial charging cable 45.1 connects the device energy storage 31 to the charging pole 43 and a second partial charging cable 45.2 connects the charging pole 43 to the charging plug 35.

Furthermore, the at least one switch-off unit 1 and/or the at least one switch-off arrangement 5, in particular a fourth switch-off unit 1.4 or a fourth switch-off arrangement 5.4, is arranged in the charging pole 43. Preferably, the first switch-off unit 1.1 and/or the first switch-off arrangement 5.1 is also arranged in the device energy storage 31. Alternatively or additionally, the second switch-off unit 1.2 and/or the second switch-off arrangement 5.2 is arranged in the first partial charging cable 45.1. Alternatively or additionally, the third switch-off unit 1.3 and/or the third switch-off arrangement 5.3 is arranged in the charging plug 35. Alternatively or additionally, a fifth switch-off unit 1.5 and/or a fifth switch-off arrangement 5.5 is arranged in the second partial charging cable 45.1.

FIG. 7 shows a schematic representation of an embodiment example of the energy storage device 27 as the charging device 3.

The energy storage device 27 has the switch-off unit 1. The switch-off arrangement 5 of the switch-off unit 1, in particular the first power semiconductor component 9.1 and the second power semiconductor component 9.2, is electrically installed in series with a power supply device 25 connectable to the energy storage device 27 in a supply circuit 29 of the energy storage device 27.

Particularly preferably, the switch-off unit is integrated into a charging socket 47 of the energy storage device 27.

1. A switch-off unit for an electric charging device with a [switch-off arrangement] (5, 5.1, 5.2, 5.3, 5.4, 5.5) having a first controllable power semiconductor component, a second controllable power semiconductor component and a diode (10), and a switch-off control device, wherein
the first power semiconductor component and the second power semiconductor component are arranged antiserially, wherein
the diode (10), the first power semiconductor component and the second power semiconductor component are arranged as a T-circuit, wherein
the first power semiconductor component and the second power semiconductor component are configured to conduct a charging current of the charging device in a switched-on state, wherein
the switch-off control device is operatively connected to the first power semiconductor component and the second power semiconductor component and is configured for their respective control, wherein
the switch-off control device is configured to acquire a value of at least one charging parameter which is characteristic of the charging current, and
in dependence on the acquired value, to switch off the first power semiconductor component and/or the second power semiconductor component and thereby interrupt the charging current.

2. The switch-off unit according to claim 1, wherein the electric charging device is an electric power supply device and/or an electric energy storage device.

3. The switch-off unit according to claim 1, wherein the switch-off control device is configured to compare the acquired value with a charging parameter threshold value of the at least one characteristic charging parameter and, in dependence on the comparison, to switch off the first power semiconductor component and/or the second power semiconductor component and thereby interrupt the charging current.

4. The switch-off unit according to claim 3, wherein the switch-off control device is configured to variably set the charging parameter threshold value.

5. The switch-off unit according to claim 1, wherein the switch-off control device is configured to acquire as the at least one characteristic charging parameter a parameter selected from a voltage, a voltage gradient, an amperage, an amperage gradient, a magnetic field, a power, an energy flow direction, and a temperature.

6. The switch-off unit according to claim 1, wherein
the first power semiconductor component has a first semiconductor switch and a first component diode, wherein
the first semiconductor switch and the first component diode are arranged antiparallel, wherein
the second power semiconductor component has a second semiconductor switch and a second component diode, and wherein
the second semiconductor switch and the second component diode are arranged antiparallel.

7. The switch-off unit according to claim 1, wherein the switch-off control device is configured to switch off the first power semiconductor component and/or the second power semiconductor component by means of a control voltage, wherein the control voltage for switching off the first power semiconductor component and/or the second power semiconductor component is preferably at most 0 V.

8. The switch-off unit according to claim 1 with a tempering device, wherein the tempering device is configured to temper, in particular to cool or heat, at least the first power semiconductor component and/or the second power semiconductor component, wherein the tempering device is preferably formed as a water cooling system or as an air cooling system.

9. The switch-off unit according to claim 1 with a temperature control device, wherein the temperature control device is configured to acquire and/or control a temperature of the switch-off unit.

10. The switch-off unit according to claim 1 with a communication interface, wherein the communication interface is configured to receive and/or send information.

11. The switch-off unit according to claim 10, wherein the communication interface is configured to send information about an operating state of the switch-off unit and/or to receive information of a computing unit.

12. The switch-off unit according to claim 1 with an auxiliary power supply (19), wherein the auxiliary power supply (19) is configured to operate the switch-off control device, the first power semiconductor component and the second power semiconductor component.

13. A power supply device with a switch-off unit according to claim 1, wherein the switch-off arrangement (5) is electrically installed in series with an energy storage device connectable to the power supply device in a supply circuit (29) of the power supply device.

14. The power supply device according to claim 13 with a computing unit, wherein the computing unit is operatively connected to the switch-off unit and is configured to receive data from the switch-off unit and/or to send data to the switch-off unit.

15. The power supply device according to claim 13 with a device energy storage, a charging cable and a charging plug, wherein the switch-off unit is arranged in
a) the device energy storage, and/or
b) the charging cable, and/or
c) the charging plug.

16. The power supply device according to claim 13 with a charging pole, wherein the charging pole is electrically arranged between the device energy storage and the charging plug, and wherein a first partial charging cable connects the device energy storage to the charging pole and a second partial charging cable connects the charging pole to the charging plug, wherein the switch-off unit is arranged in the charging pole.

17. The power supply device according to claim 13, with a casing, wherein the casing has a maintenance hatch, and wherein the switch-off unit is arranged in the electrical power supply device in such a way that at least the first power semiconductor component and/or the second power semiconductor component can be replaced via the maintenance hatch.

18. The power supply device according to claim 13, wherein the power supply device is formed as a charging station for electrically charging an energy storage device connected to the power supply device.

19. An energy storage device with a switch-off unit according to claim 1, wherein the switch-off arrangement is electrically installed in series with a power supply device connectable to the energy storage device in a supply circuit of the energy storage device.
